(19) United States
(12) Patent Application Publication
(10) Pub. No.: US 2020/0287968 A1
(43) Pub. Date: Sep. 10, 2020

(54) DATA SYNCHRONIZATION METHOD AND APPARATUS, AND ELECTRONIC CIGARETTE

(71) Applicant: SHENZHEN AVATAR CONTROLS CO., LTD., Shenzhen City, Guangdong Province (CN)

(72) Inventor: WEIHUA QIU, Changzhou City, Jiangsu Province (CN)

(21) Appl. No.: 16/763,974

(22) PCT Filed: Dec. 14, 2018
(86) PCT No.: PCT/CN2018/121050

§ 371 Date: May 13, 2020

(30) Foreign Application Priority Data
Jan. 30, 2018 (CN) 201810087824.5

(51) Int. Cl. H04L 29/08; G06F 16/27

(52) U.S. Cl. CPC H04L 67/1095; G06F 16/27

(57) ABSTRACT

Disclosed are a data synchronization method and apparatus, and an electronic cigarette, belonging to the technical field of computers. The method includes: acquiring synchronization priority information; acquiring synchronization parameter, wherein the synchronization parameter includes at least one of limit data amount during single synchronization, unit time period corresponding to single synchronization, and generation time period of target data to be synchronized; and according to the synchronization priority information and the synchronization parameter, synchronizing the target data to be synchronized to a target device. The problem in the related art that a user needs to wait for a long time to be able to view important data recently recorded by an electronic product on a target device due to the fact that it takes a long time for the electronic product to synchronize data to the target device is solved.

### TECHNICAL FIELD

The present invention relates to the field of computer technologies, and in particular, to a data synchronization method, a data synchronization apparatus, and an electronic cigarette.

### BACKGROUND

With the continuous development of science and technology, the use of electronic products such as electronic cigarettes, sports bracelets, smart sports shoes, or the like has become more and more widespread.

At present, most of these electronic products are not convenient for installing large-sized display screens. These electronic products usually cache their recorded data locally; when connecting with a target device such as a mobile phone, a tablet, a computer, or the like, these electronic products synchronize the locally cached data to the target device for viewing by the user on the target device.

However, if the electronic product is disconnected from the target device for a long time, the electronic product may generate a large amount of stored data during the disconnection stage from the target device. Once the electronic product establishes a connection with the target device, the target device synchronizes all of its unsynchronized data to the target device, and the synchronization process may take a long time, causing the user to wait for a long time in order to view on the target device the data recently recorded by the electronic product.

### SUMMARY

In order to solve the problem in the prior art that the process of synchronizing data between the electronic product and the target device is long, and the user needs to wait for a long time in order to view on the target device the data recently recorded by the electronic product, the embodiments of the present invention provide a data synchronization method, a data synchronization apparatus, and an electronic cigarette. The technical solutions are as follows:

In a first aspect, a data synchronization method is provided. The method includes:
acquiring synchronization priority information;
acquiring synchronization parameter, wherein the synchronization parameter includes at least one of limit data amount during single synchronization, unit time period corresponding to single synchronization, and generation time period of target data to be synchronized; and
synchronizing the target data to be synchronized to a target device according to the synchronization priority information and the synchronization parameter.

Optionally, before synchronizing the target data to be synchronized to a target device according to the synchronization priority information and the synchronization parameter, the method further includes:
acquiring a first data amount of the target data; and
if the first data amount reaches the limit data amount, performing the step of synchronizing the target data to be synchronized to a target device according to the synchronization priority information and the synchronization parameter.

Optionally, if the first data amount is lower than the limit data amount during single synchronization, all the target data is synchronized to the target device.

Optionally, the synchronization priority information indicates that the synchronization priority of the data is negatively correlated with the generation duration of the data, wherein synchronizing the target data to be synchronized to a target device according to the synchronization priority information and the synchronization parameter includes:
acquiring the data that has the shortest generation duration and has a second data amount from the target data to be synchronized, wherein the second data amount is less than or equal to the limit data amount;
synchronizing the acquired data to the target device; and
if there is still unsynchronized data in the target data, performing again the step of acquiring the data that has the shortest generation duration and has the second data amount from the target data to be synchronized.

Optionally, the synchronization priority information indicates that the synchronization priority of the data is negatively correlated with the generation duration of the data, wherein synchronizing the target data to be synchronized to a target device according to the synchronization priority information and the synchronization parameter includes:
synchronizing the data generated in each unit time period to the target device sequentially in the order from late to early.

Optionally, the synchronization priority information includes the priority of multiple information types, wherein synchronizing the target data to be synchronized to a target device according to the synchronization priority information and the synchronization parameter includes:
synchronizing the data of each information type in the target data to the target device sequentially according to the priority of each information type in the order from high to low.

Optionally, before synchronizing the target data to be synchronized to a target device according to the synchronization priority information and the synchronization parameter, the method further includes:
acquiring the time when the data is last synchronized; and
if the interval between the time when the data is last synchronized and the current time is longer than a preset duration, performing the step of synchronizing the target data to be synchronized to a target device according to the synchronization priority information and the synchronization parameter.

Optionally, in the process of synchronizing the target data to be synchronized to the target device according to the synchronization priority information and the synchronization parameter, if a synchronization interrupt instruction is received, then the step of synchronizing the target data to be synchronized to the target device according to the synchronization priority information and the synchronization parameter is stopped according to the synchronization interrupt instruction

In a second aspect, a computer readable storage medium is provided. The computer readable storage medium stores therein one or more instructions, when the one or more instructions are executed by a processor within an electronic cigarette, the data synchronization method according to the first aspect and any one of the embodiments of the first aspect is implemented.

In a third aspect, a data synchronization apparatus is provided. The data synchronization apparatus includes:
a memory and a processor;
wherein the memory stores at least one program instruction;
wherein the processor, by loading and executing the at least one program instruction, implements the data synchronization method according to the first aspect and any one of the embodiments of the first aspect.

In a fourth aspect, an electronic cigarette is provided. The electronic cigarette includes the data synchronization apparatus according to the third aspect.

The beneficial effects brought by the technical solutions provided by the embodiments of the present invention are as follows:

By acquiring synchronization priority information; acquiring synchronization parameter which includes at least one of limit data amount during single synchronization, unit time period corresponding to single synchronization, and generation time period of target data to be synchronized; and synchronizing the target data to be synchronized to a target device according to the synchronization priority information and the synchronization parameter, it enables the user to view the data with highest priority on the target device as soon as possible, thereby solving the problem in the related art that the user needs to wait for a long time to be able to view the important data recently recorded by the electronic product on the target device due to the fact that it takes a long time for the electronic product to synchronize data to the target device, and achieving the effect of shortening the time of the user waiting for viewing the important data recently recorded by the electronic product.

### BRIEF DESCRIPTION OF THE DRAWINGS

In order to more clearly illustrate the technical solutions in the embodiments of the present invention, the drawings used in the description of the embodiments will be briefly described below. It is obvious that the drawings in the following description are only some embodiments of the present invention. For those of ordinary skill in the art, other drawings may also be obtained in light of these drawings without any creative efforts.

FIG. 1 is a schematic diagram of an implementation environment according to an exemplary embodiment of the present invention;

FIG. 2 is a flowchart of a method for a data synchronization method according to an embodiment of the present invention;

FIG. 3 is a flowchart of a method for a data synchronization method according to another embodiment of the present invention.

### DETAILED DESCRIPTION OF PREFERRED EMBODIMENTS

The embodiments of the present invention will be further described in detail below with reference to the accompanying drawings.

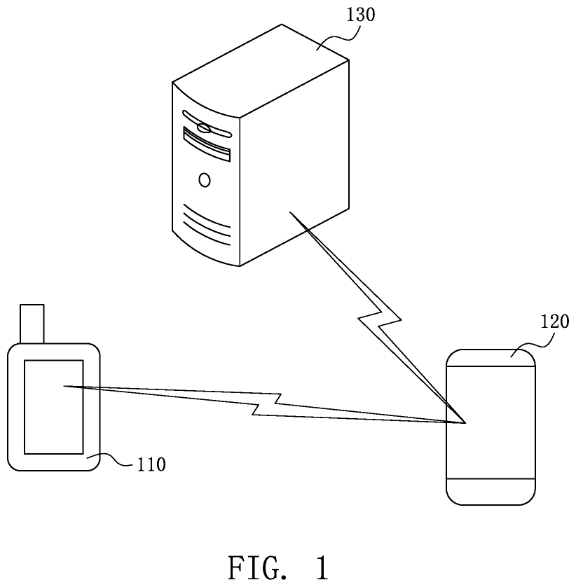

FIG. 1 is a schematic diagram of an implementation environment according to an exemplary embodiment of the present invention, including an electronic product 110 and a target device 120.

The electronic product 110 may be a product such as an electronic cigarette, a sports bracelet, a smart sports shoe, or the like. The electronic product 110 can establish a connection with the target device 120 through wireless communication technologies such as Bluetooth, NFC (Near Field Communication), or the like.

The target device 120 may be a computer device or a mobile terminal installed with an application for providing a product service for the electronic product. The mobile terminal may include a smart phone, a tablet computer, a smart TV, an e-book reader, an MP3 player (Moving Picture Experts Group Audio Layer III), an MP4 (Moving Picture Experts Group Audio Layer IV), a laptop computer, or the like.

Optionally, the implementation environment further includes a server 130. The server 130 can be a single server or a server cluster composed of multiple servers. In actual implementation, the server 130 can be connected to the target device 120 via a wired or wireless network.

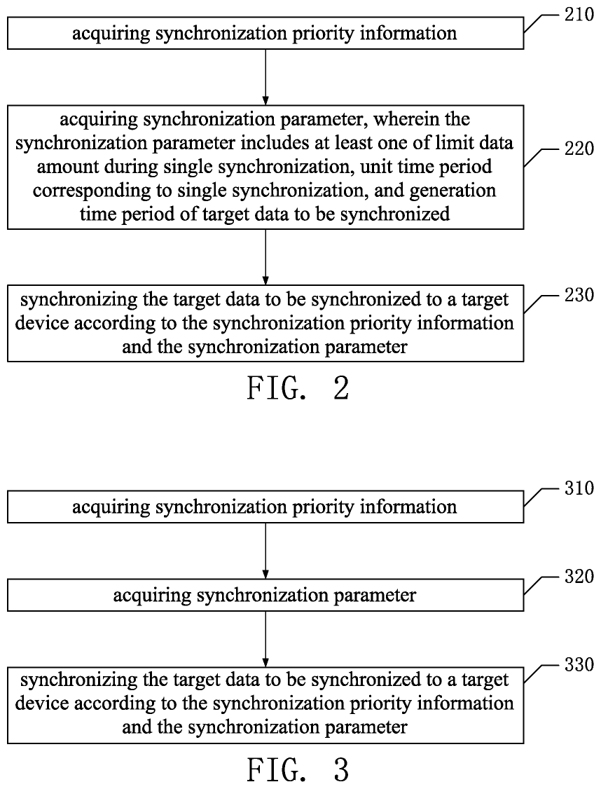

Referring to FIG. 2, it is a flowchart of a data synchronization method provided by an embodiment of the present invention. This embodiment is exemplified by the data synchronization method performed in the electronic product 110 shown in FIG. 1. As shown in FIG. 2, the data synchronization method may include:

Step 210: acquiring synchronization priority information.

Step 220: acquiring synchronization parameter, wherein the synchronization parameter includes at least one of limit data amount during single synchronization, unit time period corresponding to single synchronization, and generation time period of target data to be synchronized.

Step 230: synchronizing the target data to be synchronized to a target device according to the synchronization priority information and the synchronization parameter.

Optionally, before performing step 230, all data stored in the electronic product 110 may be determined as the target data to be synchronized, or only unsynchronized data in the electronic product 110 is determined as the target data to be synchronized.

In summary, the method provided by the embodiment of the present invention acquires synchronization priority information, acquires synchronization parameter which includes at least one of limit data amount during single synchronization, unit time period corresponding to single synchronization, and generation time period of target data to be synchronized, and synchronizes the target data to be synchronized to a target device according to the synchronization priority information and the synchronization parameter, so that it enables the user to view the data with highest priority on the target device as soon as possible, thereby solving the problem in the related art that the user needs to wait for a long time to be able to view the important data recently recorded by the electronic product on the target device due to the fact that it takes a long time for the electronic product to synchronize data to the target device, and achieving the effect of shortening the time of the user waiting for viewing the important data recently recorded by the electronic product.

Referring to FIG. 3, it is a flowchart of a data synchronization method provided by another embodiment of the present invention. This embodiment is exemplified by the data synchronization method performed in the electronic product 110 shown in FIG. 1. As shown in FIG. 3, the data synchronization method may include:

Step 310: acquiring synchronization priority information.

The synchronization priority information acquired in step 310 may be the unique synchronization priority information pre-stored in the electronic product, or may be the synchronization priority information selected by the user from a plurality of candidate synchronization priority information pre-stored in the electronic product.

Any one of the synchronization priority information stored in the electronic product may be used to indicate that the synchronization priority of the data is negatively correlated with the generation duration of the data, may include the priority of multiple information types, and may also include both.

The following describes the generation duration of the data and the information types:

First, the generation duration of the data refers to the length of time from the generation time of the data to the current time.

Second, the information types may be the categories to which the information belongs. For example, when the electronic product is a sports bracelet, the information types collected by the sports bracelet may include heart rate information, sleep information, motion information, or the like; if the user pays more attention to the heart rate information, the priority of the heart rate information can be set to the highest priority in the application. For another example, when the electronic product is an electronic cigarette, the information types collected by the electronic cigarette may include intake of harmful substances such as nicotine, output power, number of puffs, or the like; if the user pays more attention to the intake of harmful substances, the priority of the intake of harmful substances can be set by the user to the highest priority in the application. Optionally, the information types may also be the forms of the information, such as text information, picture information, audio information, video information, or the like.

Step 320: acquiring synchronization parameter.

The synchronization parameter includes at least one of limit data amount during single synchronization, unit time period corresponding to single synchronization, and generation time period of target data to be synchronized. Several cases are explained in the following.

In the first case, the synchronization parameter includes limit data amount during single synchronization, and the limit data amount during single synchronization may be set by the developer or may be customized by the user. For example, the user can set the limit data amount during single synchronization through the application installed on the target device, and the target device sends the limit data amount during single synchronization set by the user to the electronic product.

In the second case, when the synchronization parameter includes the generation time period of the target data to be synchronized, the generation time period of the target data to be synchronized may be acquired in the following manners.

In the first manner, the generation start time that is set by the user for the target data to be synchronized is acquired, the time period from the generation start time to the current time is determined as the generation time period, and the data generated by the electronic product during the generation time period is the target data to be synchronized.

For example, when the target device establishes a connection with the electronic product, the target device determines the date when the data in the electronic product is last synchronized to the target device, and provides all dates between that date and the current date for the user to select. The date selected by the user is determined as the generation start time, and the target device sends the generation start time to the electronic product.

For example, on Dec. 23, 2017, the target device establishes a connection with the electronic product. The target device determines that the date when the data in the electronic product is last synchronized is Dec. 13, 2017. Then, the target device may display a date selection option, and the user can select any date between Dec. 13, 2017 and Dec. 23, 2017 from this date selection option. If the user selects Dec. 18, 2017, then the target device sends Dec. 18, 2017, as the generation start time for the target data to be synchronized, to the electronic product.

After the electronic product acquires the generation time period, the data generated in the electronic product during the generation time period is determined as the target data to be synchronized.

In an example, the generation time period is from Dec. 13, 2017 to Dec. 23, 2017. If all stored data in the electronic product is generated from Dec. 18, 2017 to Dec. 23, 2017, then the data generated in the electronic product from Dec. 18, 2017 to Dec. 23, 2017 (i.e., all stored data) is determined as the target data to be synchronized. If all stored data in the electronic product is generated from Dec. 3, 2017 to Dec. 23, 2017, then the data generated in the electronic product from Dec. 13, 2017 to Dec. 23, 2017 is determined as the target data to be synchronized.

In actual implementation, after the electronic product acquires the generation time period, the electronic product may obtain the total amount of data generated during the generation time period; if the total amount is not higher than a preset total limit data amount of synchronization, then the data generated during the generation time period is determined as the target data, and step 330 is performed; if the total amount is higher than the preset total limit data amount of synchronization, the earliest unit time period in the generation time period is deleted until the data amount of the data generated during the generation time period is lower than the preset total limit data amount of synchronization; finally, the electronic product determines the data generated after the deletion of the earliest unit time period(s) from the generation time period as the target data to be synchronized.

In an example, the generation time period is from Dec. 13, 2017 to Dec. 23, 2017, and 24 hours on the same day is one unit time period. If the total data amount of all logs from Dec. 13, 2017 to Dec. 23, 2017 is higher than the preset total limit data amount of synchronization, then the total data amount of all logs from Dec. 14, 2017 to Dec. 23, 2017 is obtained. If the total data amount of all logs from Dec. 14, 2017 to Dec. 23, 2017 is higher than the preset total limit data amount of synchronization, then the total data amount of all logs from Dec. 15, 2017 to Dec. 23, 2017 is obtained. If the total data amount of all logs from Dec. 15, 2017 to Dec. 23, 2017 is lower than the preset total limit data amount of synchronization, then the total data amount of all logs from Dec. 15, 2017 to Dec. 23, 2017 is determined as the target data to be synchronized.

In the second manner, the generation end time that is set by the user for the target data to be synchronized is acquired; the time when the data is last synchronized is obtained, and the time period between that time when the data is last synchronized and the generation end time is determined as the generation time period, and the data generated by the electronic product during the generation time period is the target data to be synchronized.

In the third manner, the generation time period that is set by the user for the target data to be synchronized is acquired, and the data generated by the electronic product during the generation time period is the target data to be synchronized.

In the fourth manner, the current time is determined as the generation end time, the generation start time is obtained by subtracting a first preset duration from the current time, the time period between the generation start time and the generation end time is determined as the generation time period, and the data generated by the electronic product during the generation time period is the target data to be synchronized. The first preset duration may be set by the system developer or may be customized by the user. For example, the user may set the first preset duration in the application of the target device, and the target device sends the first preset duration to the electronic product for storage.

Taking the first preset duration being 10 days as an example, if the target device establishes a connection with the electronic product on Dec. 23, 2017, the electronic product obtains that the generation start time is Dec. 13, 2017 by subtracting 10 days from Dec. 23, 2017, and the generation time period corresponding to the target data to be synchronized is from Dec. 13, 2017 to Dec. 23, 2017.

In the fifth manner, all the stored data in the electronic product is determined as the target data to be synchronized, and the generation time period for these target data to be synchronized is then acquired; or all the data in the electronic product that is not synchronized is determined as the target data to be synchronized, and the generation time period for these target data to be synchronized is then obtained.

In the third case, the synchronization parameter further includes unit time period corresponding to single synchronization. The unit time period may be the default time period in the electronic product, and may also be a user-defined time period. For example, it can be a day, six hours or an hour by default.

Step 330: synchronizing the target data to be synchronized to a target device according to the synchronization priority information and the synchronization parameter.

This step can be achieved in the following manners.

In the first implementation manner, the synchronization priority information indicates that the synchronization priority of the data is negatively correlated with the generation duration of the data; and the first implementation manner may be: synchronizing the data generated in each unit time period to the target device sequentially in the order from late to early.

Taking 24 hours in a day as an example of one unit time period, if the generation time period is from Dec. 13, 2017 to Dec. 15, 2017, then the multiple unit time periods included in the generation time period are: 24 hours on Dec. 13, 2017, 24 hours on Dec. 14, 2017, and 24 hours on Dec. 15, 2017. The electronic product first synchronizes its logs on Dec. 15, 2017 to the target device, then synchronizes the logs on Dec. 14, 2017 to the target device, and finally, synchronizes the logs on Dec. 13, 2017 to the target device.

Usually, when the user connects the electronic product with the target device, the user, most of the time, wants to view on the target device the recent recorded data of the electronic product. By synchronizing the data generated in each unit time period to the target device sequentially in the order from late to early, the data recently recorded by the electronic product is first synchronized to the target device, so that the user can view the recent recorded data of the electronic product as soon as possible.

In the second implementation manner, the synchronization priority information includes the priority of multiple information types; and the second implementation manner may be: synchronizing the data of each information type in the target data to the target device sequentially according to the priority of each information type in the order from high to low.

By synchronizing the data of each information type in the target data to the target device sequentially according to the order of priority from high to low, the data of the information type most concerned by the user is first synchronized to the target device, so that the user can view the data of the information type most concerned on the target device as soon as possible.

Optionally, when the synchronization priority information includes the priority of multiple information types, meanwhile the generation time period of the data of each information type may also be considered. That is, the implementation of synchronizing the data of each information type to the target device can be: acquiring the data of this information type and its corresponding generation time period, acquiring the multiple unit time periods included in the generation time period according to time division, and synchronizing the data of this information type in each unit time period to the target device sequentially in the order from late to early.

In the third implementation manner, the data that has the shortest generation duration and has a second data amount is acquired from the target data to be synchronized, wherein the second data amount is less than or equal to the limit data amount, and the acquired data is then synchronized to the target device. If there is still unsynchronized data in the target data, the step of acquiring the data that has the shortest generation duration and has the second data amount from the target data to be synchronized is performed again, and the acquired data is then synchronized to the target device.

When the electronic product performs again the step of acquiring the data that has the shortest generation duration and has the second data amount from the target data to be synchronized, the target data to be synchronized is the remaining data excluding the data that has been synchronized since the start of synchronization, and does not include the data that has been synchronized.

Optionally, when the total data amount of the unsynchronized data in the target data is greater than or equal to the limit data amount during single synchronization, the second data amount is equal to the limit data amount during single synchronization; however, when the total data amount of the unsynchronized data in the target data is less than the limit data amount during single synchronization, the second data amount is the total data amount of the unsynchronized data in the target data.

In an example, the limit data amount during single synchronization is 2 M and the total amount of the target data is 5 M. The electronic product first synchronizes the 2 M data having the shortest generation duration to the target device, then synchronizes the 2 M data having the shortest generation duration to the target device from the remaining 3 M data that is not synchronized in the target data, and finally synchronizes the 1 M data that is not synchronized in the target data to the target device.

It should be noted that after the target device receives the synchronization data sent from the electronic product, the synchronization data may also be synchronized to the server. Specifically, the user account registered in the target device may be acquired, so that the synchronization data is stored in the server together with the user account.

In summary, the method provided by the embodiment of the present invention acquires synchronization priority information, acquires synchronization parameter which includes at least one of limit data amount during single synchronization, unit time period corresponding to single synchronization, and generation time period of target data to be synchronized, and synchronizes the target data to be synchronized to a target device according to the synchronization priority information and the synchronization parameter, so that it enables the user to view the data with highest priority on the target device as soon as possible, thereby solving the problem in the related art that the user needs to wait for a long time to be able to view the important data recently recorded by the electronic product on the target device due to the fact that it takes a long time for the electronic product to synchronize data to the target device, and achieving the effect of shortening the time of the user waiting for viewing the important data recently recorded by the electronic product.

Optionally, during performing step 330, the total data amount that has been synchronized to the target device during the synchronization process may be counted; if the total data amount is not lower than the total limit data amount of synchronization, step 330 is stopped, otherwise step 330 is continued to be performed.

Optionally, if step 330 is performed using the foregoing first implementation manner, during performing step 330, the total data amount that has been synchronized to the target device during the synchronization process is counted; if the total data amount is not lower than the total limit data amount of synchronization, the unit time periods corresponding to the data that is still not synchronized in the target data are displayed; if a unit time period selected by the user is acquired from the displayed unit time periods, then the data generated in the unit time period selected by the user is synchronized to the target device, otherwise step 330 is stopped.

Optionally, if step 330 is performed using the foregoing second implementation manner, during performing step 330, the total data amount that has been synchronized to the target device during the synchronization process is counted; if the total data amount is not lower than the total limit data amount of synchronization, then the information types corresponding to the data that is still not synchronized in the target data are displayed; if an information type selected by the user is acquired from the displayed information types, the data of the information type selected by the user in the target data is synchronized to the target device, otherwise step 330 is stopped.

In an example, before performing the various steps in any of the above embodiments, the electronic product may also acquire the time when the data is last synchronized; if the interval between the time when the data is last synchronized and the current time is longer than a second preset duration, then the above steps in the embodiments are performed, otherwise all the stored data in the electronic product is synchronized to the target device.

For example, the electronic product acquires the time when the data is last synchronized before acquiring the synchronization parameter; if the interval between the time when the data is last synchronized and the current time is longer than the second preset duration, it means that the amount of data stored in the electronic product may be large, therefore, at this time, the step of acquiring the synchronization parameter is performed, otherwise all the stored data in the electronic product is synchronized to the target device.

In an example, before performing step 330, the electronic product may further acquire a first data amount of the target data; if the first data amount is lower than the limit data amount during single synchronization, all the target data is synchronized to the target device; if the first data amount reaches the limit data amount during single synchronization, then the electronic product performs step 330. However, in actual implementation, when the first data amount is lower than the limit data amount during single synchronization, the electronic product may also perform step 330 to implement data synchronization, which is not limited in the embodiments.

In an example, in the process of synchronizing the target data to be synchronized to the target device according to the synchronization priority information and the synchronization parameter, if a synchronization interrupt instruction is received, then the step of synchronizing the target data to be synchronized to the target device according to the synchronization priority information and the synchronization parameter is stopped according to the synchronization interrupt instruction.

Optionally, the electronic product may further acquire a third data amount that has been synchronized to the target device in the target data, and update the synchronization parameter according to the third data amount.

For example, in the process of receiving the data synchronized by the electronic product, the target device may display an synchronization interrupt button in an interface of the application; if the user does not have the patience to wait for the data synchronization of the electronic product to be finished, the user may press the synchronization interrupt button; when the electronic product detects that the synchronization interrupt button is pressed and triggered, it sends a synchronization interrupt instruction to the electronic product.

After receiving the synchronous interrupt instruction, the electronic product stops the data synchronization to the target device according to the synchronous interrupt instruction, determines a third data amount that has been synchronized to the target device during the synchronization process, and updates the limit data amount during single synchronization or the first preset duration according to the third data amount, so as to reduce the time-consuming for the electronic product to perform data synchronization to the target device next time.

The updating of the limit data amount during single synchronization according to the third data amount may be: setting the third data amount as the limit data amount during single synchronization.

The updating of the first preset duration according to the third data amount may be: acquiring the highest data amount that the electronic product can generate in one unit time period, and calculating the second duration according to the highest data amount and the third data amount. For example, if the third data amount is 10 M, one unit time period is one day, and the highest data amount that can be generated by the electronic product in one day is 1 M, then the third data amount 10 M is divided by the highest data amount 1 M to obtain the quotient 10, and the quotient 10 is multiplied by the unit time period to get the first preset duration being 10 days.

An embodiment of the present invention further provides a computer readable storage medium having stored therein one or more instructions that are implemented by a processor within an electronic cigarette to implement the data synchronization method in any of the above embodiments.

An embodiment of the present invention further provides a data synchronization apparatus, wherein the data synchronization apparatus includes: a memory and a processor; the memory stores at least one program instruction; and the processor loads and executes the at least one program instruction to implement the data synchronization method in any of the above embodiments.

The embodiment of the invention further provides an electronic cigarette, and the electronic cigarette includes the data synchronization apparatus.

The terms “first” and “second” are used for descriptive purposes only and are not to be construed as indicating or implying a relative importance or implied number of technical features indicated. Thus, the defined “first”, “second” features may include one or more of the features, either explicitly or implicitly. In the description of the present invention, “a plurality” means two or more unless otherwise stated.

The serial numbers of the embodiments of the present invention are merely for the description, and do not represent the advantages and disadvantages of the embodiments.

A person skilled in the art may understand that implementing all or part of the steps in the above embodiments may be completed by hardware, or may be executed by a computer program to instruct related hardware, and the computer program may be stored in a computer readable storage medium. The storage medium mentioned may be a read only memory, a magnetic disk, an optical disk, or the like.

The above are only the preferred embodiments of the present invention, and are not intended to limit the present invention. Any modifications, equivalents, improvements, etc., which are within the spirit of the present invention, should be included in the protection scope of the present invention.

1. A data synchronization method, comprising:
acquiring synchronization priority information;
acquiring synchronization parameter, wherein the synchronization parameter includes at least one of limit data amount during single synchronization, unit time period corresponding to single synchronization, and generation time period of target data to be synchronized; and
synchronizing the target data to be synchronized to a target device according to the synchronization priority information and the synchronization parameter.

2. The method according to claim 1, wherein before synchronizing the target data to be synchronized to a target device according to the synchronization priority information and the synchronization parameter, the method further comprises:
acquiring a first data amount of the target data; and
if the first data amount reaches the limit data amount, performing the step of synchronizing the target data to be synchronized to a target device according to the synchronization priority information and the synchronization parameter.

3. The method according to claim 2, wherein if the first data amount is lower than the limit data amount during single synchronization, all the target data is synchronized to the target device.

4. The method according to claim 1, wherein the synchronization priority information indicates that the synchronization priority of the data is negatively correlated with the generation duration of the data, wherein said synchronizing the target data to be synchronized to a target device according to the synchronization priority information and the synchronization parameter comprises:
acquiring the data that has the shortest generation duration and has a second data amount from the target data to be synchronized, wherein the second data amount is less than or equal to the limit data amount;
synchronizing the acquired data to the target device; and
if there is still unsynchronized data in the target data, performing again the step of acquiring the data that has the shortest generation duration and has the second data amount from the target data to be synchronized.

5. The method according to claim 1, wherein the synchronization priority information indicates that the synchronization priority of the data is negatively correlated with the generation duration of the data, wherein said synchronizing the target data to be synchronized to a target device according to the synchronization priority information and the synchronization parameter comprises:
synchronizing the data generated in each unit time period to the target device sequentially in the order from late to early.

6. The method according to claim 1, wherein the synchronization priority information comprises the priority of multiple information types, wherein said synchronizing the target data to be synchronized to a target device according to the synchronization priority information and the synchronization parameter comprises:
synchronizing the data of each information type in the target data to the target device sequentially according to the priority of each information type in the order from high to low.

7. The method according to claim 1, wherein before synchronizing the target data to be synchronized to a target device according to the synchronization priority information and the synchronization parameter, the method further comprises:
acquiring the time when the data is last synchronized; and
if the interval between the time when the data is last synchronized and the current time is longer than a preset duration, performing the step of synchronizing the target data to be synchronized to a target device according to the synchronization priority information and the synchronization parameter.

8. The method according to claim 1, wherein in the process of synchronizing the target data to be synchronized to the target device according to the synchronization priority information and the synchronization parameter, if a synchronization interrupt instruction is received, then the step of synchronizing the target data to be synchronized to the target device according to the synchronization priority information and the synchronization parameter is stopped according to the synchronization interrupt instruction.

9. A computer readable storage medium having stored therein one or more instructions, wherein when the one or more instructions are executed by a processor within an electronic cigarette, the data synchronization method according to claim 1 is implemented.

10. A data synchronization apparatus, comprising:
a memory and a processor;
wherein the memory stores at least one program instruction;
wherein the processor, by loading and executing the at least one program instruction, implements the data synchronization method according to claim 1.

11. An electronic cigarette comprising the data synchronization apparatus according to claim 10.
